(19) United States
(12) Patent Application Publication
(10) Pub. No.: US 2026/0079959 A1
(43) Pub. Date: Mar. 19, 2026

(54) A SYSTEM AND METHOD FOR INTER-OPERATION OF LEGACY AND OPEN COMPUTING ENVIRONMENT

(71) Applicant: Z2Open LTD, Bnei Brak (IL)

(72) Inventors: Dan KALMAR, Yavne (IL); Yosef VOLPERT, Ariel (IL)

(73) Assignee: Z2Open LTD, Bnei Brak (IL)

(21) Appl. No.: 19/109,138

(22) PCT Filed: Aug. 22, 2023
(86) PCT No.: PCT/IL2023/050889

§ 371 Date: Mar. 6, 2025

Related U.S. Application Data
(60) Provisional application No. 63/408,489, filed on Sep. 21, 2022.

(51) Int. Cl. G06F 16/25

(52) U.S. Cl. CPC G06F 16/258

(57) ABSTRACT

A method, system and computer program product, the method comprising: interpreting data in a first environment structure of first format used in a first environment to a second structure of second format used in a second environment, the interpreted data stored in an intermediate storage; activating a program for using data from the intermediate storage to produce output to be stored in a second intermediate storage; and upon program termination, interpreting the output from the second to the first structure, wherein interpreting the data and the output is performed using a mapper between the first and the second formats, wherein the formats are different in that a field in the first format is absent in the second, or vice versa, or in that a field in the first format is formatted differently in the second, or fields in the second format have different order from fields in the first format.

### TECHNICAL FIELD

The present disclosure relates to operating legacy environments and open systems in general, and enabling legacy systems to operate on modern or open-formatted data, in particular.

### BACKGROUND

Large organizations have been using legacy systems since the early days of computing. Legacy systems include but are not limited to mainframe computers. Enormous amount of software has been programmed and tested for these systems, and are being used for many decades. Some of the systems are used for critical missions including bulk data processing for tasks such as banking, finance, governmental, airlines, and other large-scale transaction processing, military, industry, and others.

Many of the programs for these computers, such as COBOL, RPG or others are imperative, procedural languages. In addition to the inherent limitations of such languages including but not limited to the inability to use input/output data in open formats and protocols and to dynamically allocate memory, their popularity among programmers is constantly dropping and it is often hard to find programmers that can maintain existing programs and even more program new ones.

These limitations, in addition to the criticality of the missions handled by these systems make it hard to migrate the legacy systems to open technologies, and thus limit the options to make them cheaper, more up-to-date, user friendly, adapted to the developing needs.

### BRIEF SUMMARY

One exemplary embodiment of the disclosed subject matter is a computer-implemented method comprising: interpreting data in a first environment structure of a first format used in a first environment to a second structure of a second format used in a second environment, the data as interpreted stored in an intermediate storage; activating a program in the second environment, wherein the program is activated by a broker configured to use data from the intermediate storage to produce output to be stored in a second intermediate storage; and upon the program termination, interpreting the output in the second intermediate storage from the second structure to the first structure, wherein interpreting the data and the output is performed using a mapper which maps between the first format and the second format, and wherein the first format is different from the second format at least in that one or more data fields in the first format are absent in the second format, or one or more data fields in the second format are absent in the first format, or in that one or more data fields in the first format are formatted differently in the second format, or data fields in the second format have different order from data fields in the first format. Within the method, the first environment is optionally an open environment and the second environment is optionally a legacy environment. Within the method, the first environment is optionally a legacy environment and the second environment is optionally an open environment. The method can further comprise activating the program in the second environment, and providing the program with access to the intermediate storage. Within the method, the program is optionally configured to use an Application Program Interface (API) to get values from the intermediate storage and put values into a second intermediate storage. Within the method, the program in the second environment can optionally access dynamically allocated memory locations for reading and writing, in accordance with business logic of the program in the second environment. Within the method, the second format is optionally a format accessible to the API. Within the method, the program in the second environment is optionally adapted to: receive an address of the intermediate storage; read data from the intermediate storage; and write data to a second intermediate storage. Within the method, the second format is optionally a format accessible to the program in the second environment. Within the method, the data optionally comprises a tree structure. Within the method, the data optionally comprises an array. Within the method, the array is optionally a multi-dimensional array.

Another exemplary embodiment of the disclosed subject matter is a system having a processor, the processor being adapted to perform the steps of: interpreting data in a first environment structure of a first format used in a first environment to a second structure of a second format used in a second environment, the data as interpreted stored in an intermediate storage; activating a program in the second environment, wherein the program is configured to use data from the intermediate storage to produce output to be stored in a second intermediate storage; and upon the program termination, interpreting the output in the second intermediate storage from the second structure to the first structure, wherein interpreting the data and the output is performed using a mapper which maps between the first format and the second format, and wherein the first format is different from the second format at least in that one or more data fields in the first format are absent in the second format, or one or more data fields in the second format are absent in the first format, or in that one or more data fields in the first format are formatted differently in the second format, or data fields in the second format have different order from data fields in the first format. Within the system, the first environment is optionally an open environment and the second environment is optionally a legacy environment, or the first environment is optionally a legacy environment and the second environment is optionally an open environment. The system can further comprise activating the program in the second environment, and providing the program with access to the intermediate storage. Within the system, the program is optionally configured to use an Application Program Interface (API) to get values from the intermediate storage and put values into a second intermediate storage. Within the system, the program in the second environment can optionally access dynamically allocated memory locations for reading and writing, in accordance with business logic of the program in the second environment. Within the system, the second format is optionally a format accessible to the API. Within the system, the program in the second environment is optionally adapted to: receive an address of the intermediate storage; read data from the intermediate storage; and write data to a second intermediate storage, and wherein the second format is a format accessible to the program in the second environment.

Yet another exemplary embodiment of the disclosed subject matter is a computer program product comprising a computer readable storage medium retaining program instructions, which program instructions when read by a processor, cause the processor to perform a method comprising: interpreting data in a first environment structure of a first format used in a first environment to a second structure of a second format used in a second environment, the data as interpreted stored in an intermediate storage; activating a program in the second environment, wherein the program is configured to use data from the intermediate storage to produce output to be stored in a second intermediate storage; and upon the program termination, interpreting the output in the second intermediate storage from the second structure to the first structure, wherein interpreting the data and the output is performed using a mapper which maps between the first format and the second format, and wherein the first format is different from the second format at least in that one or more data fields in the first format are absent in the second format, or one or more data fields in the second format are absent in the first format, or in that one or more data fields in the first format are formatted differently in the second format, or data fields in the second format have different order from data fields in the first format. Within the computer program product, the first environment is optionally an open environment and the second environment is optionally a legacy environment, or the first environment is optionally a legacy environment and the second environment is optionally an open environment.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic illustration of the gaps between a legacy system and an open system;

FIG. 2A is a flowchart of steps in a generalized method for using legacy programs by open programs, in accordance with some embodiments of the disclosure;

FIG. 2B is a flowchart of steps in a method for interpreting open data structures into legacy data structures or proprietary data structures, in accordance with some embodiments of the disclosure;

FIG. 2C is a flowchart of steps in a method for interpreting legacy or proprietary data structures into open data structures, in accordance with some embodiments of the disclosure;

FIG. 3 is a block diagram of a system implementing a first embodiment of data conversion and usage, in accordance with some exemplary embodiments of the disclosure;

FIG. 4A is a flowchart of a method for creating and using a mapper, in accordance with some embodiments of the disclosure;

FIG. 4B is a flowchart of steps in a method for interpreting a tree structure in runtime, in accordance with some embodiments of the disclosure;

FIG. 4C is a schematic illustration of a multi-level array, in accordance with some embodiments of the disclosure;

FIG. 4D is a flowchart of steps in a method for interpreting an array in runtime, in accordance with some embodiments of the disclosure;

FIG. 5 is a block diagram of a system implementing a second embodiment of data conversion and usage, in accordance with some exemplary embodiments of the disclosure; and

FIG. 6 is a flowchart representing an adaptation of the flowchart of FIG. 2A to the system disclosed in FIG. 5, in accordance with some embodiments of the disclosure.

### DETAILED DESCRIPTION

The discussion below uses a mainframe and mainframe environment as an example to legacy systems or environments; COBOL and RPG languages or programs as examples to legacy programming languages or programs. Java, Python or C++ as examples to modern languages; open programs as examples to programs written in such languages, and open systems, as an example to modern systems. However, it is appreciated that these are merely examples and that the disclosure is equally applicable, respectively, to any legacy system, environment or computing platform and not necessarily a mainframe; any programming language or program used on such legacy environment and not necessarily COBOL or RPG; any modern language and not necessarily Java Python or C++; and any system, computing platform or environment enabling manipulation of modern data structures, such as but not limited to JSON, XML, by removing limitations or restrictions.

The same applies also to other terms such as format, data structures, or the like, i.e., any mention related to traditional or legacy entity may be associated with the legacy systems, and any mention of modern or open entity may be associated with the open environment.

The term “intermediate storage” relates to a storage area allocated and populated in an open or a legacy environment, and transmitted to the other environment using common tools. Thus, an open environment may allocate and populate a storage area containing input data to be processed by a legacy program, and the area with the data may be transmitted to the legacy environment. The legacy environment may allocate and populate a storage area containing output data to be provided to the open environment, and the area with the data may be transmitted to the open environment.

One technical problem addressed by the disclosure is the need to modernize legacy programs executed by legacy environments, such as but not limited to mainframe computers. The modernization may enable to improve parts of the programming tasks, move parts of the programming tasks to other computing platforms or programs written in modern programming languages and to inter-connect between the traditional systems and the modern systems, cater data by other systems, or the like, and thereby enhance performance, enable new features, and reduce the operational cost of the employing organizations. However, such modernization may be hard due to the inherent limitations of the languages and environments, in addition to the lack of programmers who can maintain or write programs in the legacy languages, and the criticality of many of the existing applications.

Another technical problem addressed by the disclosure relates to traditional languages lacking certain features which are considered obvious in modern environments. For example, traditional languages do not support memory allocation of dynamically determined sizes or structures, and are thus limited to data structures, such as arrays, of known sizes. This limitation disables the creation of a data structure that is guaranteed to include all the fields that need to be read, and thus makes the application designer break a transmission into smaller parts and then change the code of the reading program accordingly.

Yet another technical problem addressed by the disclosure is the scarcity of programmers skilled in legacy languages and environments that can develop new applications for such environments.

Yet another technical problem addressed by the disclosure is the differences in formats, storage and other aspects between legacy systems and modern systems.

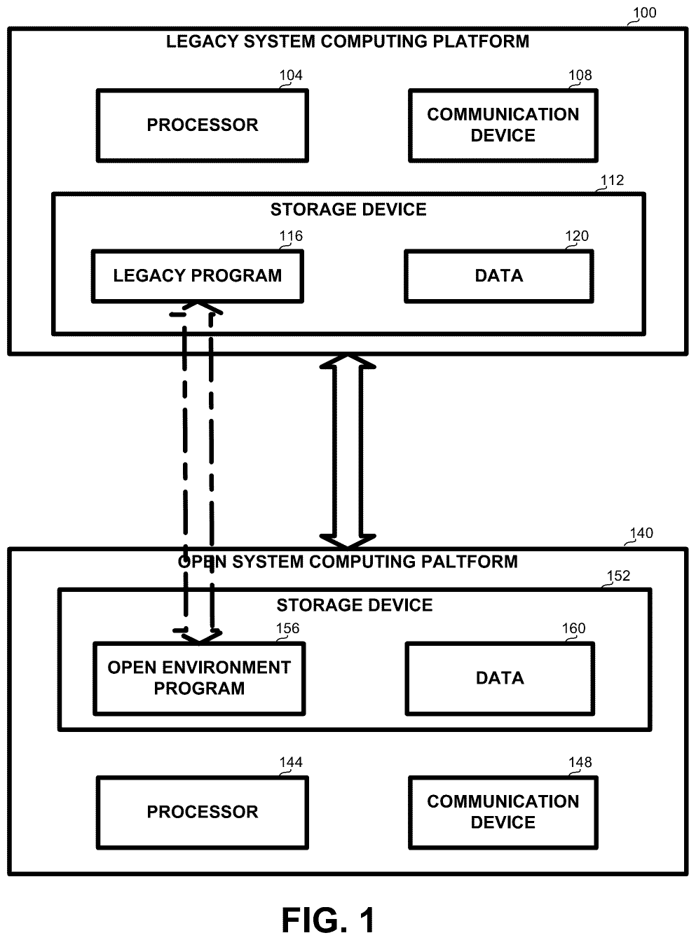

Referring now to FIG. 1 showing a schematic illustration of the gaps between a legacy system and an open system.

A legacy system comprises at least one legacy system computing platform 100. Computing platform 100 may be, for example a computer of the IBM Z series or I Series operating with the Z/OS or i5/OS operating systems. Computing platform 100 may comprise a processor 104 which may be one or more Central Processing Units (CPUs), a microprocessor, an electronic circuit, an Integrated Circuit (IC) or the like. Processor 104 may be configured to provide the required functionality, for example by loading to memory and activating the modules stored on storage device 112 detailed below.

It will be appreciated that legacy system computing platform 100 may be implemented as one or more computing platforms which may be operatively connected to each other. It will also be appreciated that processor 104 may be implemented as one or more processors, whether located on the same platform or not.

Legacy system computing platform 100 may comprise communication device 108 to transmit and receive data to and from other computing platforms over a network, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, or various other types of network communications.

Legacy System Computing Platform 100 may comprise a storage device 112, such as a tape, a virtual tape, a hard disk drive, a Flash disk, a Random Access Memory (RAM), a memory chip, or the like. In some exemplary embodiments, storage device 112 may retain program code operative to cause processor 104 to perform acts associated with any of the modules or steps of the systems and methods listed below. The program code may comprise one or more executable units, such as standalone programs, functions, libraries, or the like, adapted to execute instructions as detailed below.

Storage device 112 may comprise one or more legacy programs 116, written for example in COBOL, RPG, or the like, and data 120, which may be implemented as a database, stored on a tape, or the like and storing data to be read and/or manipulated by any of legacy programs 116. Data 120 may be stored and retrieved in a format that is accessible to legacy programs 116.

Open system computing platform 140 may comprise open system processor 144, such as one or more Central Processing Units (CPU), a microprocessor, an electronic circuit, an Integrated Circuit (IC) or the like. For a non-limiting example, open system processor 144 may be of the Intel Zeon family. In some embodiments, processor 144 may execute the Linux, UNIX or Microsoft Windows operating systems. Processor 144 may be configured to provide the required functionality, for example by loading to memory and activating the modules stored on storage device 152 detailed below.

It will be appreciated that computing platform 140 may be implemented as one or more computing platforms which may be operatively connected to each other. It will also be appreciated that processor 144 may be implemented as one or more processors, whether located on the same platform or not.

Computing platform 140 may comprise communication device 148 configured to transmit and receive data to and from other computing platforms over a network, as detailed for communication device 108 above.

Computing platform 140 may comprise a storage device 152, such as a hard disk drive, a Flash disk, a Random Access Memory (RAM), a memory chip, or the like. In some exemplary embodiments, storage device 152 may retain program code operative to cause processor 144 to perform acts associated with any of the modules or steps of the methods listed below. The program code may comprise one or more executable units, such as standalone programs, functions, libraries, or the like, adapted to execute instructions as detailed below.

Storage device 152 may comprise one or more open environment programs 156, written for example in Java, C++, C#, Python, or the like, and modern data 160, storing data to be read and/or manipulated by any of open environment programs 156. Data 160 is stored and retrieved in a format that is accessible to open environment programs 156, such as but not limited to JSON, XML or the like.

However, open environment programs 156 and legacy program 116 cannot interpret and retrieve the field and array data from information transmitted from one to the other, in the manner in which the model data of the open environment is translated or synchronized with the legacy system. Thus, data 160 and data 120 are incompatible, meaning that legacy program 116 cannot use open environment data 160, and open environment programs 156 cannot use data 120.

Thus, a solution in accordance with the problems above may be required to handle data conversion externally to the legacy business logic as exercised by legacy program 116, and enable open system applications such as open environment program 156 to reuse legacy programs without having to change the legacy programs.

The solution may also be required to provide tools for easy enhancement of existing legacy programs to use data from an open system, or development of new programs in legacy languages. For achieving these goals, a method and system in accordance with the disclosure may need to enable efficient data conversion from open system format such as JSON or XML to legacy format and vice versa, at high volumes, with no added processing cost, enable the enforcement of advanced schema rules, and support open system data types and structure sizes.

One technical solution of the disclosure is a method and system for enabling legacy programs to be invoked by open systems, and use data provided by the open system, wherein the data conversion to a format or in a manner accessible to the legacy program is performed automatically.

Thus, in accordance with the disclosure, an open system program may invoke a web service, such as but not limited to a Liberty Web Service executed on a mainframe computer by a Java Virtual Machine (JVM). The web service may invoke a broker that converts input data provided by the open system program, such that the converted data is accessible to the legacy program, directly or indirectly through API services. The converter may be programmed in a language used in an open environment, such as Java. The web service, the converter, or another program called by the converter may invoke a program in the legacy environment, referred to as COBOL broker. The COBOL broker may invoke the required legacy program, which may use the converted data, and output data. The converter may then convert the data back to the open system format, to be stored, further processed, displayed to a user, used by any other program, or the like.

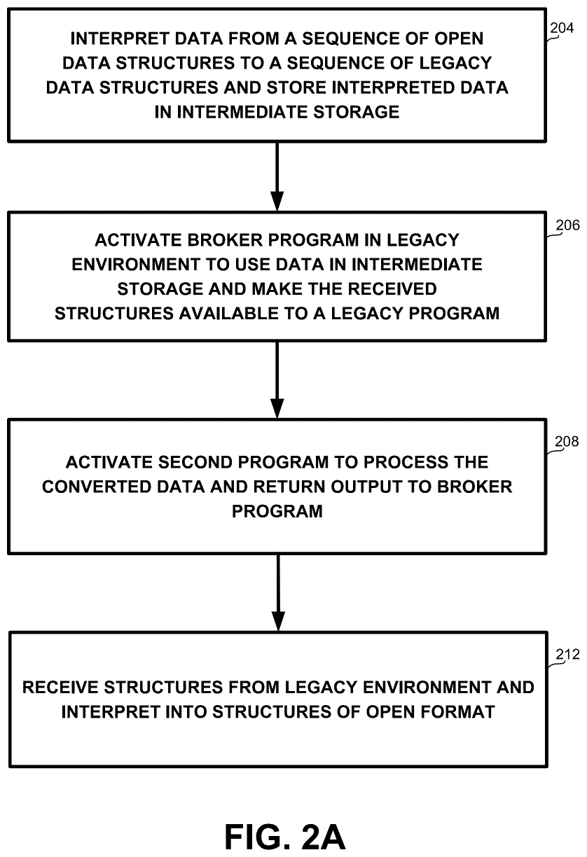

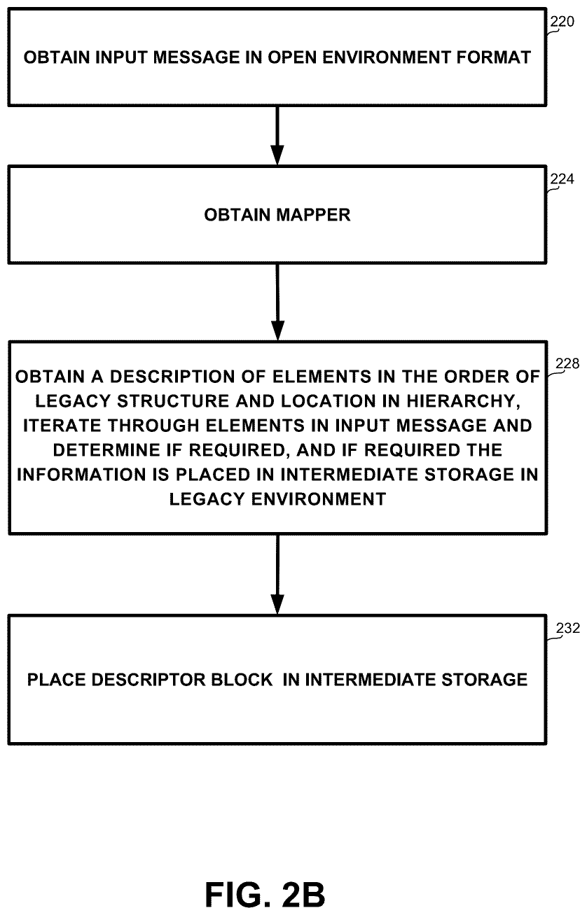

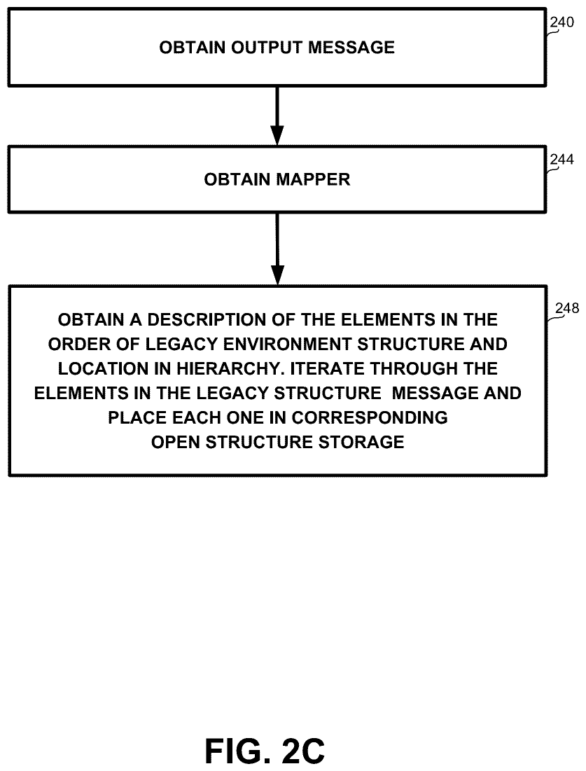

Referring now to FIG. 2A, showing a flowchart of steps in a generalized method for using legacy programs by programs executed in open environments, while overcoming the incompatibilities and the inability to associate data in a modern data structure with corresponding data in the legacy data structure, in accordance with some embodiments of the disclosure.

In the discussion below, the term “first” relates to entities associated with the open environment, such as the open computing platforms, programs executed thereby, corresponding data structures, or the like. Similarly, the term “second” relates to entities associated with the legacy environment, such as the legacy computing platforms for example a mainframe computer, programs executed thereby, corresponding data structures, or the like.

On step 204, a first program used in a first environment, which may be an open environment, written for example in Java, may interpret data from a first sequence of structures usable in the first environment to a second sequence of structures of a second format usable in a second environment, such as a legacy environment. The second format may be a format directly useable by a legacy program executed in the legacy environment, a proprietary format, or any other intermediate format The second sequence of structures may be stored in an intermediate storage accessible to the second environment. In some embodiments, for example if the legacy program overwrites its input with its output, the intermediate storage areas may also be used as an intermediate storage in the other direction. Step 204 is further detailed in association with FIG. 2B below.

On step 206, the first program may activate a broker program in the second environment. The broker may be adapted to make the sequence of structures stored in the intermediate storage available to the second program, executed for example by the legacy environment, wherein the second program is useful in processing the input data. The second program may be programmed in a legacy language, such as COBOL, or the like. The broker may thus be adapted to arrange the data in the second format, for example change the order of structures and store the structures in a linkage section, such that the second program can process the input data.

On step 208, the second program may execute, process the data and provide its output to the broker. The broker may store the output data in the intermediate storage which may be provided to the open system

On step 212, the first system, such as the open system, may receive the structures as provided by the broker, and may interpret them to be useable by a program in the first environment. Step 212 is further detailed in association with FIG. 2B below.

The conversion from the open format to the legacy (or proprietary) format and back enables the usage of open structure data, by flattening an object into a structure acceptable by the legacy language or by the API, and/or building back an object, thus overcoming the limitation of the legacy program being unable to handle modern data structure e.g., JSON or XML.

The data conversion and usage may be performed in a plurality of embodiments. This is enabled also by the isolation of the data representation forms from the code of the legacy programs. The isolation is provided by executing the legacy program by the broker, such that the instructions for data conversion are external to the legacy program code.

For legacy programs that are to be used as is and cannot be changed, the input conversion may be from the open system format to the legacy system format, such as COBOL format, such that the interpreted input is stored in a location from which the broker can read it. Once the broker makes the data available to the second program, such as a legacy program. The second program may then thus operate over its input and return its output to the broker. The broker may provide data to the first system where the interpreter may interpret the data to the open system format.

In another embodiment, when the legacy program can be written, rewritten, or enhanced, an Application Program Interface (API) is provided to get data from the open environment and use the data in the legacy environment. Thus, the legacy program can call the API functions to access the data for reading and writing. Since the use of input data and the transfer of output data occurs following the logic of the newly designed legacy program, both input and output data can be easily accessed and processed. This embodiment enables the usage of a proprietary intermediate format used by multiple programs based on the same API.

Whether the legacy program can be re/written or not, accessing the data may be implemented hierarchically, such that the legacy program will receive the data correctly.

Whether the legacy program can be re/written or not, the data conversion may be performed in accordance with automatic mapping between the open system structure and the legacy structure. For example, corresponding data structures may be associated, identical or similar fields may be matched, and default values may be assigned.

The matching may not require full matching of the data structures. Thus, the open system structures may comprise additional fields not used by the legacy program, and these fields need not be converted. Moreover, the order of the fields may be different between the two structures, and the format of specific fields may be different. It is appreciated that the above differences may also be applicable in the reverse transformation, from the legacy format to the open format.

Referring now to FIG. 2B, showing a flowchart of steps in a method for interpreting open data structures such as JSON or XML into legacy data structures such as COBOL or into a proprietary data structure, in accordance with some embodiments of the disclosure. For example, the method may be used when the legacy program cannot be changed or rewritten, but is to be used as is.

On step 220 the input structures may be obtained by the open environment, wherein the data is in the open environment format. The data may be received in a batch of structures, one by one, or in any other manner. The data may be read from a file, received over a communication channel, or the like.

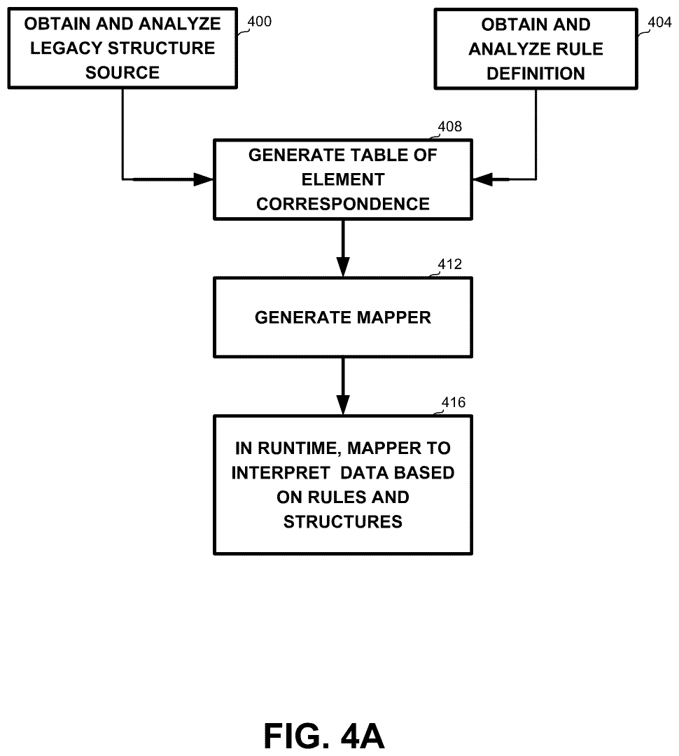

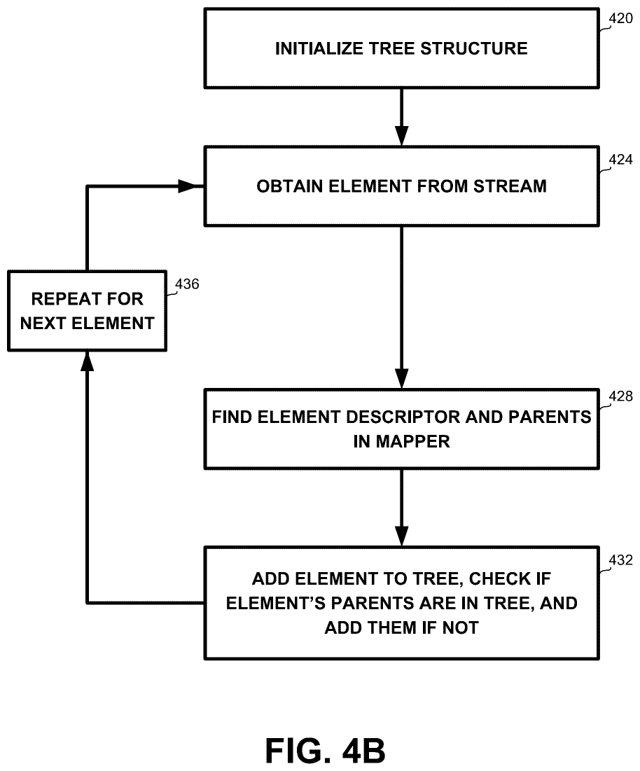

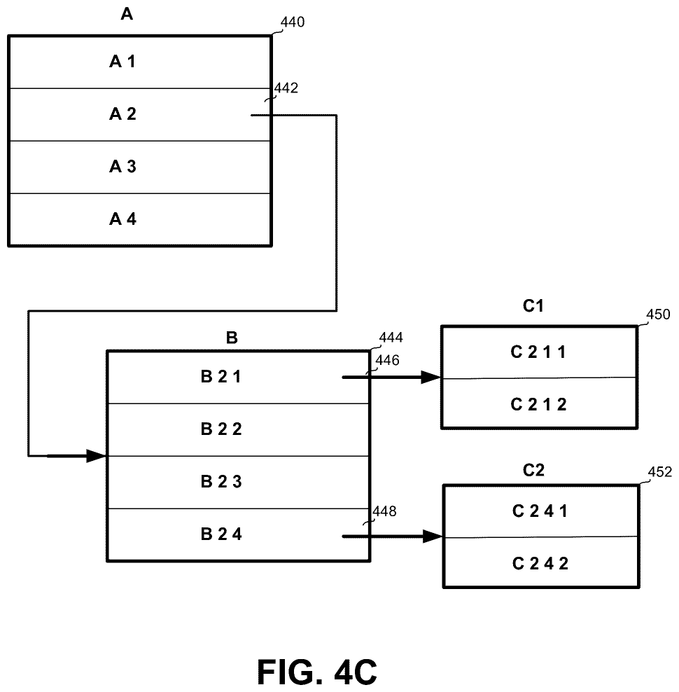

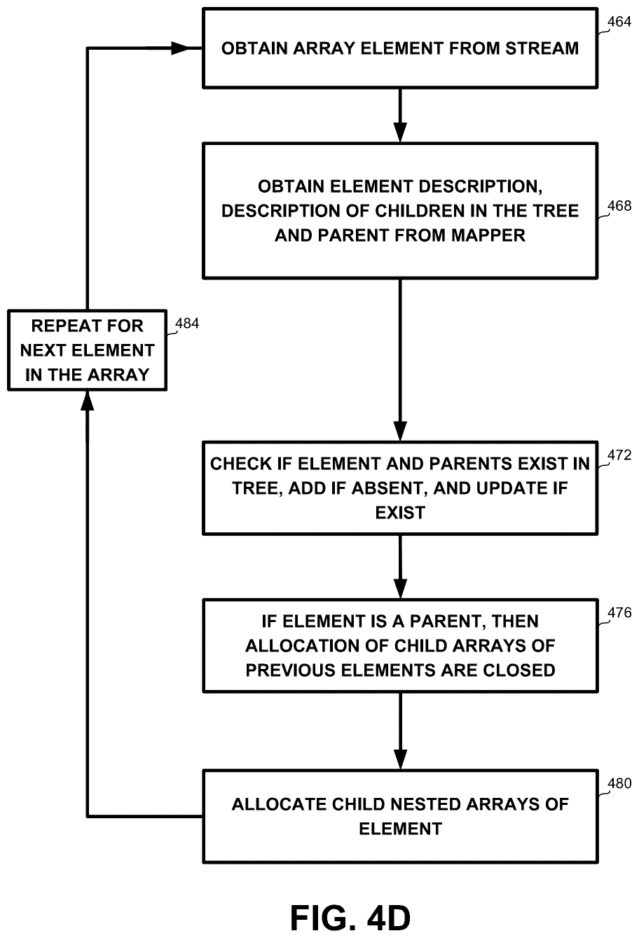

On step 224 a mapper may be obtained, which provides the mapping from the data fields in an open format to the data fields in the required second or proprietary format. Generating the mapper is further described in association with FIG. 4 below.

On step 228, the required fields of the data in the open format may be mapped to the required fields elements in the legacy or proprietary format. Thus, the fields in the input structure may be iterated, and for each one it may be determined whether and how it is required in the legacy or proprietary format. If the field is required, it is placed (after possibly being formatted) in the required field location in an intermediate storage Step 228 is further detailed in association with FIGS. 4B-4D below.

On step 232, a descriptor block comprising characteristics of the data now available to the legacy system may be stored in the intermediate storage.

FIG. 2C shows a flowchart of translating the legacy output to output to be used by the open system

Referring now to FIG. 2C, showing a flowchart of steps in a method for interpreting legacy data structures such as COBOL or proprietary data structures into open data structures, in accordance with some embodiments of the disclosure.

On step 240 the output message structure may be obtained from the legacy environment, wherein the data is in the legacy format or the proprietary format. The data may be stored in the intermediate storage, such that it can be accessed by the open system.

On step 244, the mapper may be obtained, for mapping from the data fields in the legacy format or the proprietary format to the data fields in the open format.

On step 248, the output messages may be processed and converted into the open format. The legacy program may have output only the minimum necessary information and in the most convenient order for the legacy program. For example, the output stream of messages, may locate a single element located at a certain level of the message hierarchy. The data interpreter operating within the framework of the open system may attempt to supplement the output structure, which includes that element, and optionally additional required elements. The interpreter may look for the additional elements within the structure and, if it finds them, places them in the right place in the hierarchy. If the elements are not found, the first program may check if the elements are necessary, and if they are either sets a default value or reports that the required element is missing. Thus, the presence of the element A in the output stream causes a cascade reaction of the interpreter, recreating the data hierarchy described by the structure order. The first program may thus reconstruct the structure, and may also, for example, add incomplete control data blocks, remove redundant control data blocks, reorganize control data blocks according to the description without moving data, or the like. The process may be executed for each element inside the output stream, including elements of static arrays. Thus, if a static array can contain a fixed number of elements, and the output stream contains a smaller number of them, the structure built by the first program will include the required number of array elements. Similarly, the interpreter processes dynamic arrays. Interpretation of multidimensional arrays may be performed in a way convenient for the legacy program, in which the appearance of an array element of a level higher than the current one in the output stream stops the allocation of the current instance of the array and opens the possibility of allocating a new instance.

One technical effect of the disclosure provides for consuming services from legacy programs by open programs. This effect enables to continue using legacy programs verified over decades of usage with no change, while maximizing utilization of existing applications without increasing the associated costs, since all provided operations such as the interpretation but excluding the mere processing, may be performed by other machines such as open environments.

Another technical effect of the disclosure provides for enhancing existing legacy programs or writing new ones were possible, such that the programs can enjoy new capabilities not supported by the traditional language, in a manner which is advantageous as it uses the legacy program for efficiency in some required tasks, and open system programs for the other tasks.

Yet another technical effect of the disclosure provides for dynamic memory allocation of unlimited sizes, which may support large or small memory requirements without pre-committing to unnecessary large areas nor to small memory areas which may be insufficient in rare cases. This feature enables, for example, dynamic multidimensional arrays and arrays of unlimited sizes.

Yet another technical effect of the disclosure provides for automatic interpretation of data structures used by legacy programs and open system programs and vice versa, in a manner that minimizes the human labor required for matching between the structures.

Yet another technical effect of the disclosure is to the correspondence of the order of the individual data elements between the input/output structure. The order relates to the order of the structures, their hierarchy, the order of elements within the structures and the order of elements of multidimensional dynamic arrays in the input data stream. This provides for flexibility, as the open environment structure can change and evolve over time, but wherein no change is required in the second program nor in the conversion program.

Yet another technical effect of the disclosure provides for using open environment where possible, thereby avoiding unnecessary loading of legacy environment processor, and reducing the operational costs of the overall system.

Yet another technical effect of the present invention is a method of partial data transmission by the legacy program, wherein the rest of the data may be completed by the open environment where possible.

Yet another technical effect of the invention is a technique for automatically constructing a single unified detailed description of the interacting data structures on both sides and the conversion therebetween, thereby reducing the risk of a lack of synchronization of such a description in different environments.

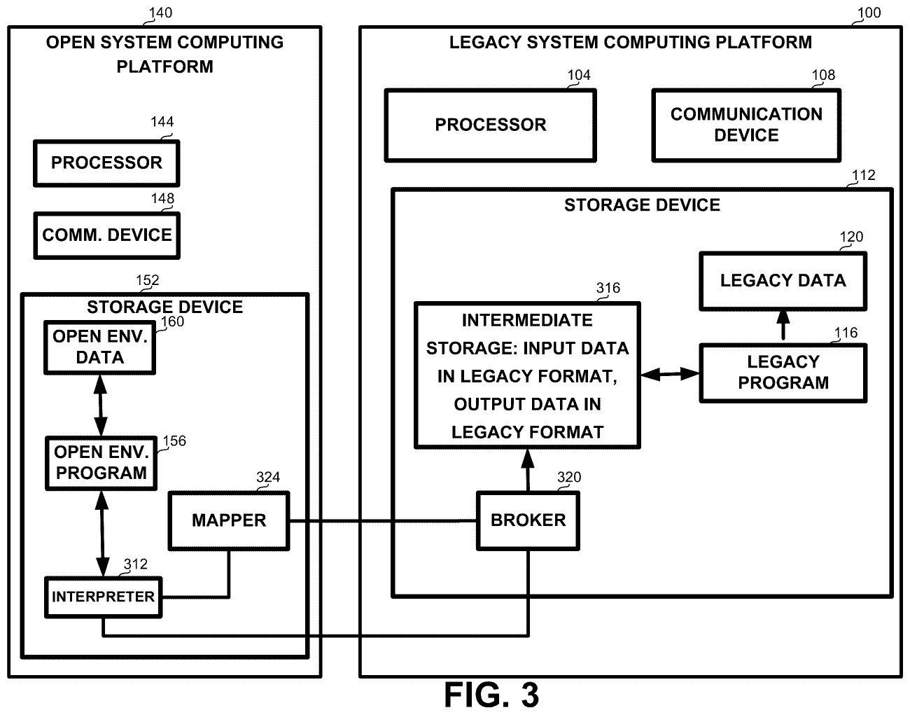

Referring now to FIG. 3, showing a block diagram of a system implementing the first embodiment of data conversion and usage, in accordance with some exemplary embodiments of the disclosure.

The system comprises legacy computing platform 100 with processor 104, communication device 108 and storage device 112, and open system computing platform 140 with processor 144, communication device 148 and storage device 152 as detailed in association with FIG. 1 above. It is appreciated that the open system computing platform may be implemented by any physical machine, including within the legacy environment, e.g., within a mainframe computer.

Open system 140 comprises open program 156 and open data 160 as also detailed in association with FIG. 1 above. Open data 160 may be stored in any format, such as JSON, XML, or the like.

Open program 156 may invoke an interpreter 312, written for example in Java, for interpreting open data 160 into input data in legacy format. The interpreted data may be stored in an intermediate storage.

Interpreter 312 may also invoke broker 320, written in a legacy language, for example in COBOL, and provide it with the intermediate storage. Broker 320 may process the data and store a descriptor block in the parameter area, the descriptor block containing parameters to be used by legacy program 116.

Broker 320 may invoke the required legacy program 116. Legacy program 116 may receive the parameters from the descriptor block, process the data in the traditional manner, such that no changes are required to legacy program 116. The results may be stored in a legacy intermediate data for transferring the results to the open environment. Legacy program 116 may receive the data either thorough broker 320 parsing parameter pointing at the relevant data.

When legacy program 116 exits, and some output is ready and stored in the parameter area, legacy program 116 may return control to broker 320 which may return control to interpreter 312. Interpreter 312 may interpret the data in an intermediate area storing the output data, into a format useful to the open system, and may provide the output to the invoking open program 156.

Thus, legacy program 116 may not require any change, can work with the data it expects, and provide the expected output. This enables to keep executing legacy programs, but wherein the programs are invoked from an open system and can be used as part of a modern system.

Interpreter 312 may do the interpretation of open data 160 into the legacy structures and back using mapper 324. Mapper 324 may be created beforehand. Mapper 324 may map the structures between the open environment and the legacy environment and vice versa. Each structure may comprise additional fields which are not available on the other structure. Moreover, these fields may change between executions, for example in some activations there are some fields the other system is oblivious about, and in other activations there are other fields the other system is oblivious about. The mapping rules may be defined using a single dedicated tool, and used for the two-way translation, i.e., interpreting the input from the open structures to the legacy structures and interpreting the output in the reverse direction using the same definitions. Thus, if a change is required in either structure, the change needs to only be introduced once.

Further, even for a plurality of fields that exist in both structures, the order of fields is not necessarily maintained between the two structures. Moreover, the format of corresponding fields is often not identical between the two structures.

Mapper 324 may thus be created automatically, manually, or in a hybrid manner. For example, manual or automatic mapping may be performed between the fields having identical or similar names, and further correspondence may be indicated by a user.

Listing 1 below shows a COBOL input structure sample, and Listing 2 below shows a JSON input structure sample.

01 FILE-REQ-MSG.

| | |
|---|---|
| 03 KEY-COUNT | PIC 9(8). |
| 03 NUMBER | OCCURS 100 TIMES PIC 9(6) |
| | DEPENDING ON KEY-COUNT. |
| 03 USER-PARM | PIC X(8). |
| | Listing 1 |

```
″FLARQMSG″:{
  ″UserParm″:“Bla - bla - bla”,
  “Number″:[″000001″, ″000102″, ″000104″, ″000106″, ″001222″]}
```

Listing 2

Thus, in some embodiments, the field names may be automatically matched. It is appreciated that matching may or may not require exact string matching. For example, the field “KEY-COUNT” in the COBOL data structure may be matched with “KeyCount” in the JSON data structure. The matching may then be subject to approval or changes by a human user. For example, a user may be presented with the full data structures and the assumed field correspondence, whether the fields have perfect or imperfect string matches. The user may then approve or reject each field matching, change the format of one or more fields, change the field order in either data structure, or the like.

It is appreciated that the interpretation may be asymmetrical. For example, the legacy format or the open format may comprise fields not comprised by the other format.

Referring now to FIG. 4A, showing a flowchart of generating a mapper and mapping objects, in accordance with some embodiments of the disclosure.

On step 400, a description of one or more legacy structures may be obtained and analyzed. Listing 3 below shows such exemplary structure.

Listing 3

| | | |
|---|---|---|
| 07 | CASH-L. | |
| 09 | TOTAL-CASH-IN | PIC9(8) V99 VALUE 0. |
| 09 | TOTAL-CASH-OUT | PIC9(8) V99 VALUE 0. |

Analysis may comprise interpreting the various fields, their types and the interrelationships.

On step 404, rule definition of a rules for mapping the legacy structures as obtained and analyzed to open structures may be obtained and analyzed to make the correspondence between fields of the legacy structure and of the open structure. The rule definition may be obtained from the structure definitions or from one or more dedicated records.

In some embodiments, the rule definition may be embedded within the legacy structures, for example as comment lines in the legacy structure definition. Listing 4 below shows the same structures as Listing 3, with additional comment lines describing the rules. In such embodiments, steps 400 and 404 are performed concurrently.

* Z2ARRAY

| *Z2EXT_NAME | | LocalCurrency |
|---|---|---|
| 07 | CASH-L. | |
| *Z2EXT_NAME | | TotalCash_IN |
| | 09 | TOTAL-CASH-IN PIC 9(8) V99 VALUE 0. |
| *Z2EXT_NAME | | TotalCash_OUT |
| | 09 | TOTAL-CASH-OUT PIC 9(8) V99 VALUE 0. |
| | | Listing 4 |

On step 408, based on the inputs received on steps 400 and 404, a correspondence may be generated between the legacy data structure and the open structure. In the example of Listing 4, the legacy structure CASH-L is mapped to LocalCurrency, TOTAL-CASH-IN is mapped to TotalCash_IN and TOTAL-CASH-OUT is mapped to TotalCash_OUT.

In some embodiments, an initial correspondence, based for example on string similarity, may be suggested automatically and may be reviewed by a user. Alternatively, the correspondence may be performed by matching corresponding fields as described in the example of Listing 1 and Listing 2 above or by a user developing external definitions.

On step 412 a mapper program, module or another executable unit may be generated upon the correspondence. The mapper may be adapted to be executed by the open system, and its input or output may be transmitted from or to, respectively, the intermediate storage. Some mapping objects may also be used on the legacy system by the broker or API for getting data from the intermediate storage.

It is thus appreciated that the whole apparatus comprises a single mapper, deriving its definitions from a single location, thereby ensuring consistency and uniformity. Step 412 is further detailed in association with FIGS. 4B-4D below.

On step 416, Once the mapper is generated, it may be used as part of operating the system. The mapper may thus be used by the interpreter to interpret the input data provided by the open system and convert it to the legacy format, based on the structures and the rule definitions. The data may then be provided to the broker and used by the legacy program. When ready, the output may be provided to an intermediate storage on the open system, and converted into the required open format.

It is appreciated that the mapper may maintain the hierarchy present in the legacy program. For example, if a legacy structure comprises an element, the mapper is adapted to populate the levels which are higher in the hierarchy than the element.

Referring now to FIG. 4B, showing a flowchart of steps in a method for interpreting in runtime an element in a structure, in accordance with some embodiments of the disclosure.

The method of FIG. 4B is applicable in both directions: interpreting input data in open format into legacy format, and interpreting output data legacy format to open format.

On step 420 the initial structure may be initialized, such as a tree structure, for example by allocating the required space for the structure.

On step 424, an element may be obtained from a stream, whether it is an element of an input stream or of the output stream.

On step 428, a description of the element, and a description of the element's parents, i.e., elements for which the current element is a sub-element or a descendent may be obtained from the mapper, as generated on step 412 of FIG. 4.

On step 432, the element may be added to the tree generated on step 420 and populated, in accordance with the definitions as obtained from the mapper. It is then checked whether the element's parents are already stored on the tree, and if not, they may be added. Fields for which no value is available may be assigned default values.

On step 436 if may be checked whether additional elements are present in the stream, and execution may return to step 424 for obtaining the next element in the structure.

It is appreciated that the method is relevant whether the input data as converted is available to the legacy environment directly or using an API.

Referring now to FIG. 4C, showing a schematic illustration of a multi-level array, which may be implemented in the open environment as well as in the legacy environment. The data structure comprises element A 400, having 4 elements A1, A2, A3 and A4, each of which is an array in itself. Thus. element A2 442 comprises array B 444, also having four elements B21 (446), B22, B23 and B24 (448), each of which is also an array. Thus, element B21 (446) comprises array C1 450, having element C211 and C212. Element B24 (448) comprises array C2 452, having element C241 and C242.

It is appreciated that for each entry in array B, the number of elements in the C array may be different. When a new element is added to an existing array, it is appended at the end, such that the order is maintained.

Once an element is populated, for example element B22 is populated, the previous elements, such as element B21 are closed and no further elements can be stored therein.

Referring now to FIG. 4D, showing a flowchart of steps in a method for interpreting in runtime an element in an array, in accordance with some embodiments of the disclosure. Interpretation can be used in both directions: from the open environment to the legacy environment, or vice versa. The array may be a single level or a multi-level array.

On step 464, an array element is obtained from the stream, whether it is the input stream in the open environment, or the output stream in the legacy environment.

On step 468, the element description, e.g., its type is obtained from the mapper. Also obtained are the description of its parents, e.g., the array that the current element belongs to, and its children, e.g. the arrays that are contained in one or more entries of the current array.

On step 472, it is checked whether the element and its parents are already present in the tree. If they are not, they may be added, with default values where applicable, updated if they exist but the values are different, for example new non-default values are available.

On step 476, if the value is a parent, such as element B24 of array B (444) whose children are stored in array C2 (452), then the subarrays of the previous entries, e.g., array C1 (450) need to be closed for further allocation.

On step 480, the child elements, e.g., array C2 (452) are allocated and optionally populated with default values.

On step 484 if may be checked whether additional elements are present in the stream, and execution may return to step 424 for obtaining the next element in the array.

Thus, the tree structure is populated with the current element, and space is allocated for its children. If no value is later provided for the children, they may be assigned default values.

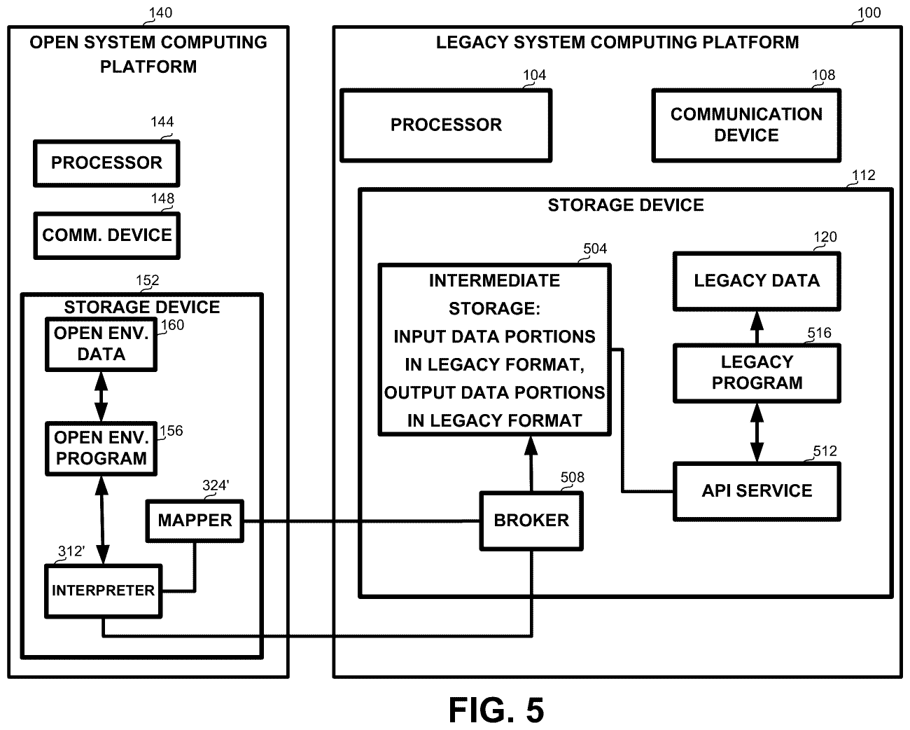

Referring now to FIG. 5, showing a block diagram of a system implementing the second embodiment of data interpretation and usage, in accordance with some exemplary embodiments of the disclosure.

As in FIG. 3, the system comprises legacy system computing platform 100 with processor 104, communication device 108 and storage device 112, and open system computing platform 140 with processor 144, communication device 148 and storage device 152 as detailed above. Open system 140 comprises open program 156 and open data 160. Open program 156 may invoke or use interpreter 312′ for interpreting open data 156 into input data in legacy format or into a proprietary format. The data may be transmitted to intermediate storage 504, accessible to API services 512. Intermediate storage 504 may thus comprise portions of the input data and portions of the output data in legacy format. It is appreciated that in some embodiments, intermediate storage 504 may comprise different areas allocated for the input data and for the output data.

API services 512 may be called by legacy program 516 adapted to use the API. Although the data format is referred to as proprietary, it is understood that it may also be any generally available format.

The API may comprise a “Get” or a similarly named function which legacy program 516 may call to get one or more values from the interpreted data stored in intermediate storage, and a “Put” or a similarly named function which legacy program 516 may call to set one or more values to the intermediate storage. Legacy program 516 does not read or write the data directly, but rather through the API. Therefore the format of the interpreted data and the output data does not have to be readable by legacy program 516. This may be beneficial in a plurality of ways, for example the format nay be highly efficient in space and/or time, useful for a plurality of programs, easy to implement, or the like.

Since the memory allocation is performed by interpreter 312′ which executes in the open environment, or by broker or API in the legacy environment, the memory can be allocated dynamically, without having to predetermine the size of the allocated memory. Since dynamic memory allocation is not always supported in legacy environments, this enables mainframe programs to enjoy the benefit of this feature, by reading form and writing to any location within the dynamically allocated memory.

If dynamic arrays are used in the input structure, they can be placed in control blocks in the order in which they appear in the structure hierarchy, to simplify and speed up their use by the API in the legacy program as much as possible.

The API functions may operate in a hierarchical manner, for example retrieve and create complex structures, multidimensional arrays of values, or the like. The API may use the data as stored in the intermediate storage, which as detailed above creates the legacy hierarchical structure.

Interpreter 312′ may also invoke broker 508, written in a legacy language, for example COBOL. Broker 508 may invoke legacy program 516, which may be configured to use API services 512 to read the input data and write the output data. Broker 508 may provide legacy program 516 with a handle related to the stored data rather than a memory location, since legacy program 516 does not directly access the memory. Legacy program 516 can provide the handle in calls to the API that refer to the data. Thus, if a program handles different structures in may receive and use a different handle for each such structure.

When legacy program 516 has finished processing the data, legacy program 516 may notify broker 508 which may return control to interpreter 312′. Interpreter 312′ may interpret the data in the intermediate storage into a format useful in the open system, and may provide the output to the invoking open program 156.

Thus, this embodiment can be used for executing legacy programs which can be written or adapted to use API services 512.

Interpreter 312 may do the interpretation of open data 160 into the legacy structures and back using mapper 324′. Mapper 324′ may be created as detailed above, including the degrees of freedom in not mapping all fields of the data in either side, changing the order of fields and changing formatting of specific fields.

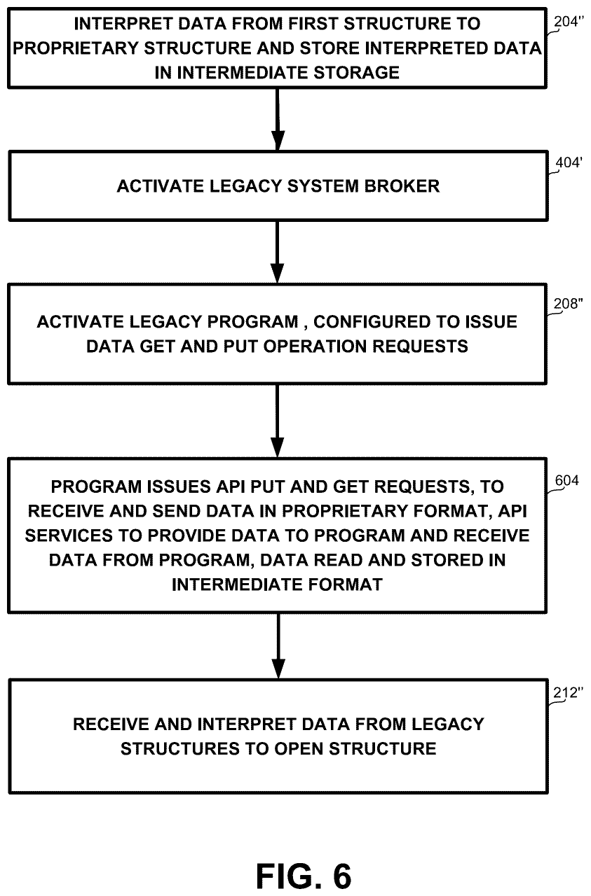

Referring now to FIG. 6, showing a flowchart representing an adaptation of the flowchart of FIG. 2 to the second implementation of data usage, as disclosed in FIG. 5 above, in accordance with some embodiments of the disclosure.

On step 204″, similarly to step 204 of FIG. 2 above, the input data is interpreted, for example by interpreter 312′. The input data may be interpreted from open data structures having a format which can be accessed by the open environment, into legacy data structures having a format which can be read and processed by the legacy environment. The interpreted data is stored in the intermediate storage.

On step 404′, the interpreter or another program may invoke broker 508 in the legacy environment

On step 208″, similarly to step 208 of FIG. 2A above, the open program, such as program 516, which is required to execute in order to process the data may be activated, for example by broker 508. Program 516 may be a legacy program adapted to use API services. Broker 508 may provide program 516 with a handle to the structures stored in intermediate storage, the handle to be provided with any call to the API services.

Thus, on step 604, program 516, as part of its operation may issue “Get” requests to the API services to retrieve data from the allocated memory where the input data is stored in the proprietary format. Program 516 may also issue “Put” requests to the API services to store data in the intermediate storage. Program 516 may provide the handle with each call to the “Get” or “Put” services.

On step 212″, similarly to step 212 of FIG. 2A, the interpreter may interpret the output data of the program, from the proprietary format into structures of the format compatible with the open environment, and may provide the output to the open program 156. The interpreter may start interpreting only when the legacy program has finished processing all its input and has terminated.

It is appreciated that while the disclosure is more focused on operating a legacy program form an open environment, this is not a limitation and the disclosure is equally applicable to the symmetric situation in which an open program is activated from a legacy program, and the data conversion is performed in the opposite directions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
interpreting data in a first environment structure of a first format used in a first environment to a second structure of a second format used in a second environment, the data as interpreted stored in an intermediate storage;
activating a program in the second environment, wherein the program is executed by a broker configured to use data from the intermediate storage, to produce output to be stored in a second intermediate storage; and
upon the program termination, interpreting the output in the second intermediate storage from the second structure to the first structure, wherein
interpreting the data and the output is performed using a mapper which maps between the first format and the second format, and wherein
the first format is different from the second format at least in that at least one data field in the first format is absent in the second format, or
at least one data field in the second format is absent in the first format, or in that at least one data field in the first format is formatted differently in the second format, or
data fields in the second format have different order from data fields in the first format.

2. The method of claim 1, wherein the first environment is an open environment and the second environment is a legacy environment.

3. The method of claim 1, wherein the first environment is a legacy environment and the second environment is an open environment.

4. The method of claim 1, further comprising activating the program in the second environment, and providing the program with access to the intermediate storage.

5. The method of claim 1, wherein the program is configured to use an Application Program Interface (API) to get values from the intermediate storage and put values into a second intermediate storage.

6. The method of claim 5, wherein the program in the second environment can access dynamically allocated memory locations for reading and writing, in accordance with business logic of the program in the second environment.

7. The method of claim 5, wherein the second format is a format accessible to the API.

8. The method of claim 1, wherein the program in the second environment is adapted to:
receive an address of the intermediate storage;
read data from the intermediate storage; and
write data to a second intermediate storage.

9. The method of claim 8, wherein the second format is a format accessible to the program in the second environment.

10. The method of claim 1, wherein the data comprises a tree structure.

11. The method of claim 1, wherein the data comprises an array.

12. The method of claim 11, wherein the array is a multi-dimensional array.

13. A system having a processor, the processor being adapted to perform the steps of:
interpreting data in a first environment structure of a first format used in a first environment to a second structure of a second format used in a second environment, the data as interpreted stored in an intermediate storage;
activating a program in the second environment, wherein the program is configured to use data from the intermediate storage to produce output to be stored in a second intermediate storage; and
upon the program termination, interpreting the output in the second intermediate storage from the second structure to the first structure, wherein
interpreting the data and the output is performed using a mapper which maps between the first format and the second format, and wherein
the first format is different from the second format at least in that at least one data field in the first format is absent in the second format, or
at least one data field in the second format is absent in the first format, or in that at least one data field in the first format is formatted differently in the second format, or
data fields in the second format have different order from data fields in the first format.

14. The system of claim 13, wherein the first environment is an open environment and the second environment is a legacy environment or the first environment is a legacy environment and the second environment is an open environment.

15. The system of claim 13, further comprising activating the program in the second environment, and providing the program with access to the intermediate storage.

16. The system of claim 13, wherein the program is configured to use an Application Program Interface (API) to get values from the intermediate storage and put values into a second intermediate storage.

17. The system of claim 16, wherein the program in the second environment can access dynamically allocated memory locations for reading and writing, in accordance with business logic of the program in the second environment.

18. The system of claim 16, wherein the second format is a format accessible to the API.

19. The system of claim 13, wherein the program in the second environment is adapted to:
receive an address of the intermediate storage;
read data from the intermediate storage; and
write data to a second intermediate storage, and wherein
the second format is a format accessible to the program in the second environment.

20. A computer program product comprising a non-transitory computer readable medium retaining program instructions, which instructions when read by a processor, cause the processor to perform:
interpreting data in a first environment structure of a first format used in a first environment to a second structure of a second format used in a second environment, the data as interpreted stored in an intermediate storage;
activating a program in the second environment, wherein the program is configured to use data from the intermediate storage to produce output to be stored in a second intermediate storage; and
upon the program termination, interpreting the output in the second intermediate storage from the second structure to the first structure, wherein
interpreting the data and the output is performed using a mapper which maps between the first format and the second format, and wherein
the first format is different from the second format at least in that at least one data field in the first format is absent in the second format, or
at least one data field in the second format is absent in the first format, or in that at least one data field in the first format is formatted differently in the second format, or
data fields in the second format have different order from data fields in the first format.

21. The computer program product of claim 20, wherein the first environment is an open environment and the second environment is a legacy environment.
